(19) United States
(12) Patent Application Publication
(10) Pub. No.: US 2007/0160228 A1
(43) Pub. Date: Jul. 12, 2007

(54) AUDIO SIGNAL INPUT AND OUTPUT APPARATUS

(75) Inventors: Sung-Kai Yang, Taipei County (TW); Yu-Hsi Lan, Hsinchu County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: FORTEMEDIA, INC., Cupertino, CA (US)

(21) Appl. No.: 11/625,835

(22) Filed: Jan. 23, 2007

(30) Foreign Application Priority Data
Jan. 8, 2006 (TW) 95128123

(51) Int. Cl. H04R 1/02; H04R 3/00

(52) U.S. Cl. 381/91; 381/122

(57) ABSTRACT

An audio signal input and output apparatus includes a microphone array, a mounting part, and a main body. The mounting part is connected to the microphone array. The main body electrically connects an electronic device and the microphone array. The microphone array sends out a first audio signal through the main body to the electronic device.

### BACKGROUND OF THE INVENTION

1. Field of the Invention

The invention relates to an audio signal input and output apparatus.

2. Description of the Related Art

Microphones are the most commonly used audio signal input apparatuses. Referring to FIG. 1, an externally connected microphone module 11 stands on a surface via a base 12 thereof. The microphone module 11 contains an omni-directional microphone or a uni-directional microphone 18 to receive sound. In operation, the microphone module 11 is connected to, for example, a notebook computer (not shown) through an audio cable 14 for internet communication or sound recording.

In this case, a single microphone 18 receiving sound is susceptible to unwanted environmental noise, and echo is possible. Thus, the quality of received sound is often poor.

### BRIEF SUMMARY OF THE INVENTION

The invention provides a high-quality audio signal input and output apparatus capable of receiving sound, outputting audio signal, and even serving as a hub.

The audio signal input and output apparatus of the invention includes a microphone array, a mounting part, and a main body. The mounting part is connected to the microphone array. The main body electrically connects an electronic device and the microphone array. The microphone array sends out a first audio signal through the main body to the electronic device.

The mounting part may be a clip and the microphone array is mounted on the electronic device through the mounting part.

The mounting part may be a bar and the microphone array connects to the main body through the bar.

The audio signal input and output apparatus may further include a loudspeaker disposed outside the main body to receive a second audio signal from the electronic device through the main body.

The audio signal input and output apparatus may further include a loudspeaker disposed in the main body to receive a second audio signal from the electronic device.

The audio signal input and output apparatus may further include a power cable connecting to the main body. The power cable may be a universal serial bus (USB) cable.

The audio signal input and output apparatus may further include a battery disposed in the main body.

The main body may include a hub comprising a plurality of USB ports.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts an externally connected microphone module;

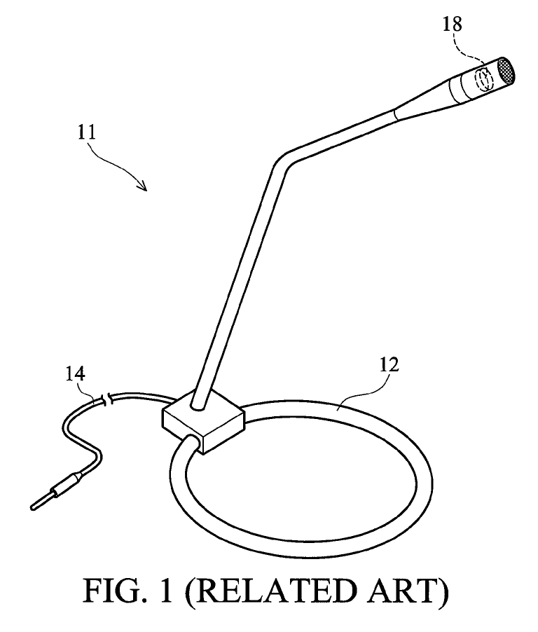

FIG. 2 depicts an audio signal input and output apparatus in accordance with a first embodiment of the invention;

FIG. 3 depicts an audio signal input and output apparatus in accordance with a second embodiment of the invention;

FIG. 4 depicts an audio signal input and output apparatus in accordance with a third embodiment of the invention; and

FIG. 5 depicts an audio signal input and output apparatus in accordance with a fourth embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

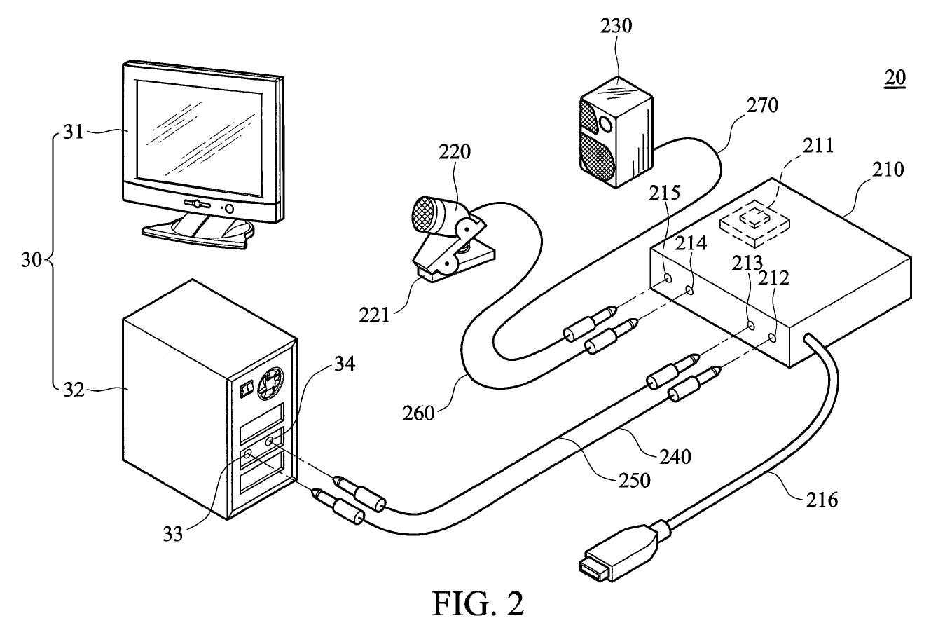

FIG. 2 depicts an audio signal input and output apparatus in accordance with a first embodiment of the invention, wherein the audio signal input and output apparatus 20 is externally connected to an electronic device, for example a desktop computer 30. In operation the audio signal input and output apparatus 20 receives sound via microphone array 220 and then sends out an audio signal to the desktop computer 30, or receives an audio signal from the desktop computer 30 and then outputs sound via loudspeaker 230.

The audio signal input and output apparatus 20 includes a main body 210, a digital signal processor (DSP) 211 disposed in the main body 210, and a power cable 216 connecting to the main body 210 for supplying power to the digital signal processor (DSP) 211. In the first embodiment, the power cable 216 is a universal serial bus (USB) cable introducing external power to the digital signal processor (DSP) 211. The power cable 216, however, can be replaced with a battery (not shown) disposed in the main body 210 to supply power.

The main body 210 includes sound input jacks 213 and 214 and sound output jacks 212 and 215 for connection between the microphone array 220, the main tower 32 of the desktop computer 30, and the loudspeaker 230, as described in detail in the following.

The microphone array 220 and the sound input jack 214 are connected by a first connecting part 260. The microphone jack 33 on the back of the main tower 32 and the sound output jack 212 are connected by a second connecting part 240. The microphone array 220 is connected to a mounting part 221. In the first embodiment, the mounting part 221 is a clip for fastening the microphone array 220 to the display 31 or other parts of the desktop computer 30. During operation, the microphone array 220 receives sound and then sends an audio signal through the first connecting part 260 to the main body 210. The digital signal processor 211 in the main body 210 executes beam-forming, noise suppression, and echo cancellation on the audio signal to obtain a processed audio signal. The processed audio signal is then transmitted through the second connecting part 240 to the main tower 32 of the desktop computer 30.

The loudspeaker 230 and the sound output jack 215 of the main body 210 are further connected by a third connecting part 270. The headphone jack 34 at the rear of the main tower 32 and the sound input jack 213 are connected by a fourth connecting part 250. During operation, the main tower 32 sends an audio signal through the headphone jack 34 and the fourth connecting part 250 to the main body 210. The digital signal processor 211 processes the audio signal and obtains a processed audio signal. The loudspeaker 230 receives the processed audio signal through the third connecting part 270 and subsequently outputs the audio signal.

The electronic device is a desktop computer in the first embodiment. It is understood, however, that the electronic device may be a notebook computer, a cellular phone, a personal digital assistant (PDA), a global positioning system (GPS),or similar.

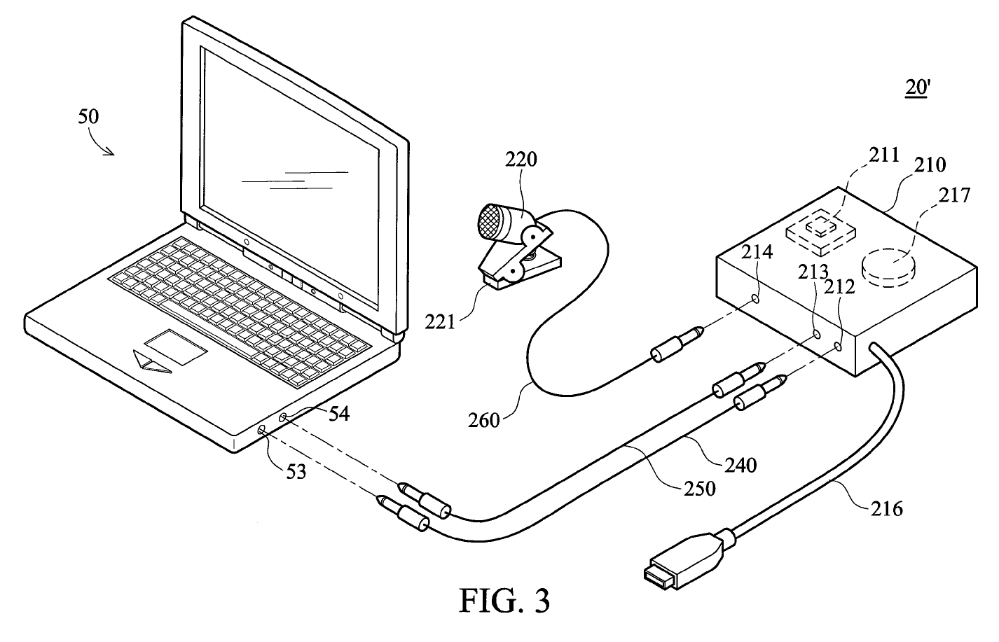

FIG. 3 depicts an audio signal input and output apparatus 20′ in accordance with a second embodiment of the invention, wherein the same references will be used for elements which are identical or similar to those in FIG. 2 and the descriptions thereof are omitted. In the second embodiment, the microphone jack 53 at the rear of a notebook computer 50 and the sound output jack 212 are connected by the second connecting part 240. During operation, the microphone array 220 receives sound and sends an audio signal through the first connecting part 260 to the main body 210. The digital signal processor 211 in the main body 210 executes beam-forming, noise suppression, and echo cancellation on the audio signal to obtain a processed audio signal. The processed audio signal is then transmitted through the second connecting part 240 to the notebook computer 50.

The headphone jack 54 of the notebook computer 50 and the sound input jack 213 of the main body 210 are connected by the fourth connecting part 250. Note that in the second embodiment the loudspeaker 217 is disposed inside, rather than outside, the main body 210. During operation, the notebook computer 50 sends an audio signal through the fourth connecting part 250 to the main body 210. The digital signal processor 211 processes the audio signal for the loudspeaker 230 to output audio.

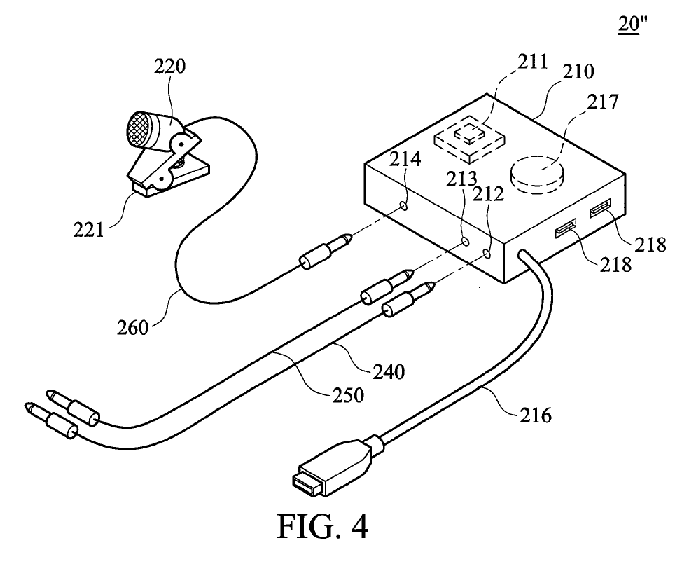

FIG. 4 depicts an audio signal input and output apparatus 20″ in accordance with a third embodiment of the invention, wherein the same references will be used for elements which are identical or similar to those in FIGS. 2 and 3. In the third embodiment, the main body 210 serves as a hub and is provided with a plurality of USB ports 218 for connecting to USB devices.

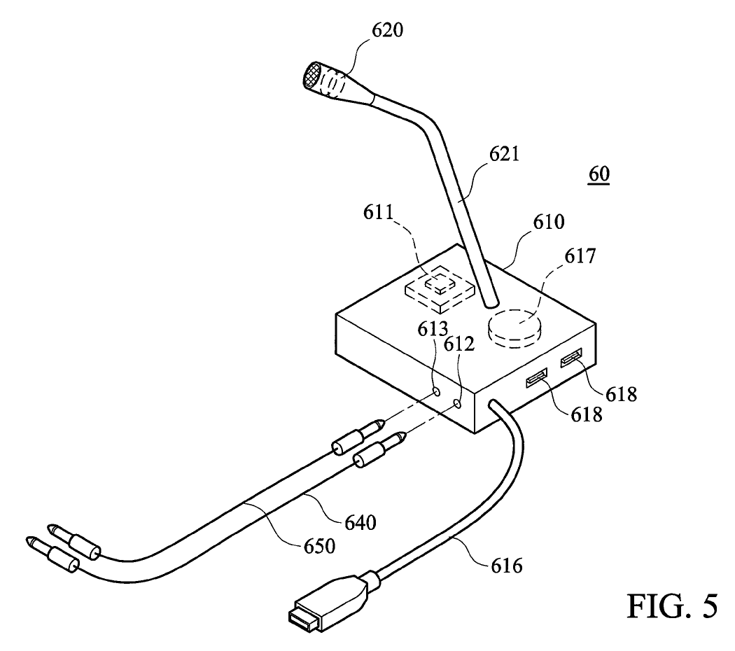

FIG. 5 depicts an audio signal input and output apparatus 60 in accordance with a fourth embodiment of the invention, wherein the mounting part 621 is a bar connected to the main body 610 to support the microphone array 620. The main body 610 has a sound input jack 613 and a sound output jack 612 connected to an electronic device through the second connecting part 640 and the fourth connecting part 650 for transmitting audio signal therebetween. The main body 610 comprises a plurality of USB ports 618 for accommodating USB devices, a digital signal processor 611 for processing the audio signal, and a loudspeaker 617 for generating audio output. A power cable 616 extends out of the main body 610 for connection to an external power source to supply power.

From the previous descriptions, it is understood that the invention provides a high-quality audio signal input and output apparatus capable of receiving sound, outputting audio signal, and even serving as a hub.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An assembly comprising:
an electronic device; and
an audio input and output apparatus externally connected to the electronic device, comprising a microphone array, a mounting part connecting to the microphone array, and a main body electrically connecting the electronic device and the microphone array, wherein the microphone array transmits a first audio signal through the main body to the electronic device.

2. The assembly as claimed in claim 1, wherein the microphone array is mounted on the electronic device through the mounting part.

3. The assembly as claimed in claim 2, wherein the mounting part is a clip.

4. The assembly as claimed in claim 1, wherein the microphone array connects to the main body via the mounting part.

5. The assembly as claimed in claim 4, wherein the mounting part is a bar.

6. The assembly as claimed in claim 1, wherein the audio signal input and output apparatus further comprises a loudspeaker disposed outside the main body to receive a second audio signal from the electronic device through the main body.

7. The assembly as claimed in claim 1, wherein the audio signal input and output apparatus further comprises a loudspeaker disposed in the main body to receive a second audio signal from the electronic device.

8. The assembly as claimed in claim 1, wherein the audio signal input and output apparatus further comprises a power cable connecting to the main body.

9. The assembly as claimed in claim 8, wherein the power cable is a universal serial bus cable.

10. The assembly as claimed in claim 1, wherein the audio signal input and output apparatus further comprises a battery disposed in the main body.

11. The assembly as claimed in claim 1, wherein the main body comprises a hub.

12. The assembly as claimed in claim 11, wherein the hub comprises a plurality of universal serial bus ports.
